(19) United States
(12) Patent Application Publication
(10) Pub. No.: US 2021/0401156 A1
(43) Pub. Date: Dec. 30, 2021

(54) ATTACHMENT ASSEMBLY FOR A DEVICE

(71) Applicant: Hand Held Products, Inc., Fort Mill, SC (US)

(72) Inventors: Jordan D. Yoder, Abington, PA (US); Blake E. Dunbar, Philadelphia, PA (US)

(21) Appl. No.: 16/910,589

(22) Filed: Jun. 24, 2020

(51) Int. Cl. A45F 5/00; H04M 1/04; A45F 5/10

(52) U.S. Cl. CPC A45F 5/004; H04M 1/04; A45F 5/10; A45F 2005/1013; A45F 2200/0516; A45F 2005/002; A45F 2005/006; A45F 2005/008

(57) ABSTRACT

The present disclosure provides an attachment assembly for a device. The attachment assembly comprises a first attachment member and a second attachment member. The first attachment member is slidable along a first axis of the device at a first location. The second attachment member is at a second location. The first attachment member and the second attachment member are configured to be coupled to a strap. A tension in the strap is configurable based on a sliding movement of the first attachment member.

### TECHNICAL FIELD

Example embodiments of the present disclosure relate generally to a device and, more particularly, to an attachment assembly for a device.

### BACKGROUND

Field observations, for example, at warehouses, factories, stores, etc., have indicated that end users equipped with handheld devices inadvertently misuse hand straps attached to the devices. For example, when a device is not being used by a user or when the user needs to utilize both hands for an operation, he/she may tend to slide his/her wrist or forearm through the hand strap. In some scenarios, when the hand strap is used to secure the device to the wrist or the forearm, the strap may be uncomfortably positioned on the wrist or the forearm. For example, the device may be typically oriented at a 90° angle to the wrist or the forearm.

### BRIEF SUMMARY

Various embodiments illustrated herein disclose an attachment assembly for a device. The attachment assembly comprises a first attachment member and a second attachment member. The first attachment member is slidable along a first axis of the device at a first location. The second attachment member is at a second location. The first attachment member and the second attachment member are configured to be coupled to a strap. A tension in the strap is configurable based on a sliding movement of the first attachment member.

Various embodiments illustrated herein disclose a device comprising a housing. The housing comprises a first attachment member and a second attachment member. The first attachment member is slidable along a first axis of the housing at a first location. The second attachment member is at a second location. The first attachment member and the second attachment member are configured to be coupled to a strap. A tension in the strap is configurable based on a sliding movement of the first attachment member.

Various embodiments illustrated herein disclose a device comprising a housing. The housing comprises a first recess, a first attachment member, and a second attachment member. The first recess extends along a first axis of the housing at a first location. The first attachment member is configured to be slidably received within the first recess. The first attachment member is slidable along the first axis of the housing at the first location. The second attachment member is at a second location. The first attachment member and the second attachment member are configured to be coupled to a strap. A tension in the strap is configurable based on a sliding movement of the first attachment member.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIGS. 1(A)-1(B) exemplarily illustrate perspective views of a device comprising an attachment assembly to be secured to a hand of a user, according to one or more embodiments described herein;

FIGS. 2(A)-2(B) exemplarily illustrate perspective views of the device comprising the attachment assembly to be secured to a forearm of the user, according to one or more embodiments described herein;

FIG. 3 illustrates a left side sectional view of a portion of the device comprising a first attachment member of the attachment assembly coupled to a strap, according to one or more embodiments described herein;

FIGS. 4(A)-4(B) exemplarily illustrate rear views of the device depicting configurations of the attachment assembly, according to one or more embodiments described herein;

FIG. 5 exemplarily illustrates another rear view of the device depicting another configuration of the device, according to one or more embodiments described herein;

FIG. 6 exemplarily illustrates another rear view of the device depicting another attachment assembly, according to one or more embodiments described herein; and

FIG. 7 exemplarily illustrates another rear view of the device depicting yet another attachment assembly, according to one or more embodiments described herein.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout. Like numbers refer to like elements throughout. Terminology used in this patent is not meant to be limiting insofar as devices described herein, or portions thereof, may be attached or utilized in other orientations.

Unless the context requires otherwise, throughout the specification and claims which follow, the word “comprise” and variations thereof, such as, “comprises” and “comprising” are to be construed in an open sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, one or more particular features, structures, or characteristics from one or more embodiments may be combined in any suitable manner in one or more other embodiments.

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such component or feature may be optionally included in some embodiments, or it may be excluded.

The present disclosure addresses problems associated with unintended uses of a hand strap attached to a portable device, for example, when a hand strap intended to be worn on the hand of the user is worn on the forearm of the user. Such scenarios may render the hand strap on the device as ineffective. The present disclosure addresses these problems by providing an attachment assembly that allows configuring a tension in the strap based on the usage of the strap.

The present disclosure provides the attachment assembly comprising a first attachment member and a second attachment member for the device. The first attachment member is slidable along a first axis of a housing of the device at a first location. The term “housing” and the term “device” are interchangeably used herein and may be regarded as synonyms. In some examples, the first axis may correspond to a longitudinal axis or a diagonal axis of the housing. The second attachment member is positioned at a second location on the device. In an example implementation, the first attachment member and the second attachment member are coupled to a rear surface of the housing. In an embodiment, a strap may be coupled to the first attachment member and the second attachment member. A tension in the strap is configurable based on a sliding movement of the first attachment member at the rear surface along the first axis of the housing. For example, when the first attachment member is in a first position, a user may insert his/her hand through the strap to comfortably attach the device on his/her hand. Further, when the first attachment member is slid to a second position, the user may insert his/her forearm through the strap to comfortably secure the device to the forearm.

In an example implementation, the first location may correspond to a location proximal to a first corner of the housing, and the second location may correspond to a location proximal to a second corner of the housing. In an example embodiment, the first corner and the second corner may be diagonally opposite to each other. In some examples, the positioning of the first attachment member at the first location and the second attachment member at the second location on the rear surface of the housing ensures that the strap is diagonally oriented thereby, providing an ergonomic device handling experience to the user.

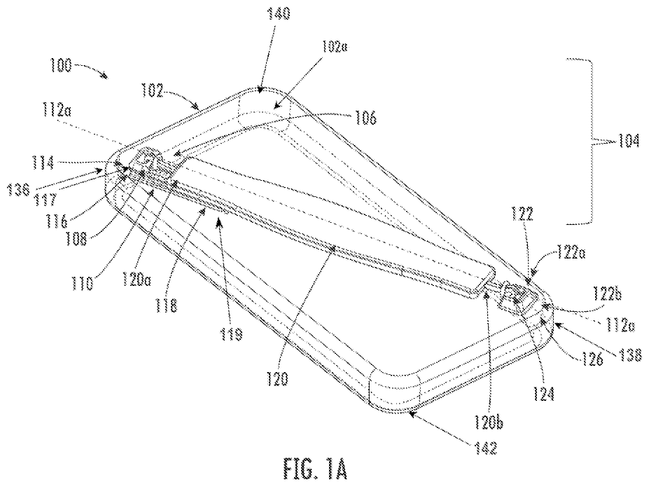

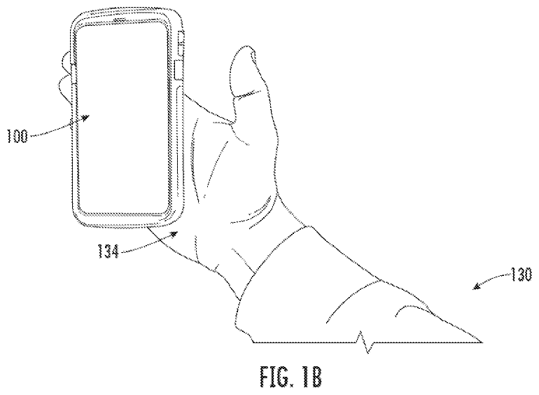

FIGS. 1(A)-1(B) exemplarily illustrate perspective views of an attachment assembly 104 positioned on a device 100 to allow the device 100 to be secured to a hand 134 of a user 130, according to one or more embodiments described herein.

In some examples, the device 100 may correspond to a mobile device, a portable computer, a mobile computer, a handheld computer, a scanning device, a smartphone, a tablet computer, an indicia reader (such as a barcode scanner), a sled device such as Honeywell Captuvo™ Enterprise Sled, or any other portable electronic device. For the purpose of brevity and ongoing description, different components of the device 100 have not been described.

In an example embodiment, the attachment assembly 104 comprises a first attachment member 106 and a second attachment member 122, according to one or more embodiments described herein. As used herein, the “first attachment member” and the “second attachment member” refer to mechanical elements configured to be removably attached to the device 100. Additionally, or alternatively, the first attachment member 106 and the second attachment member 122 are configured to be coupled to a strap 120. In an example implementation, the first attachment member 106 and the second attachment member 122 are in the shape of a bracket, a hook, a toggle latch, a clamp, etc.

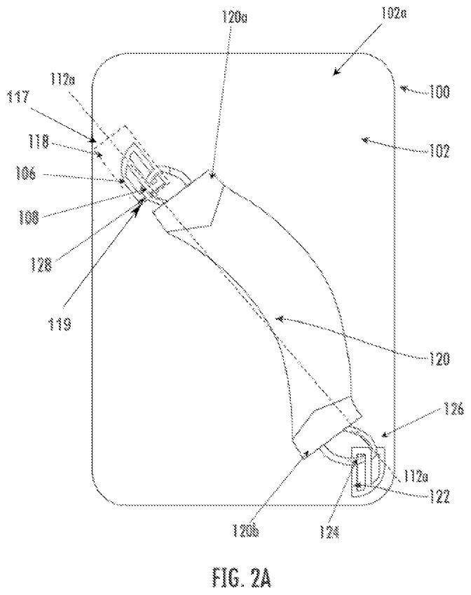

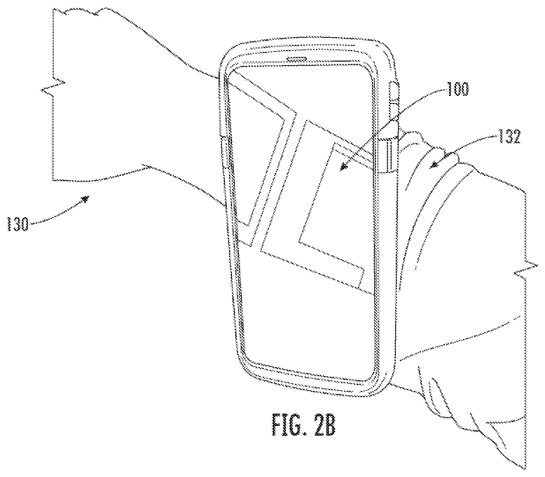

In some examples, the attachment assembly 104 may be coupled to the device 100, as explained in detail below in the detailed description of FIGS. 1(A)-1(B) and 2(A)-2(B).

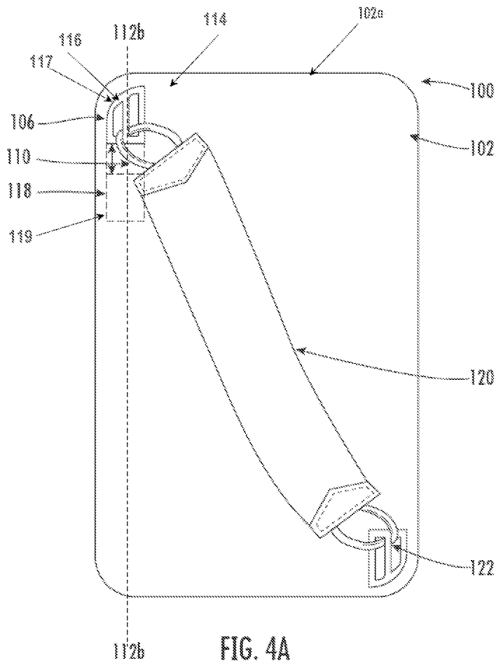

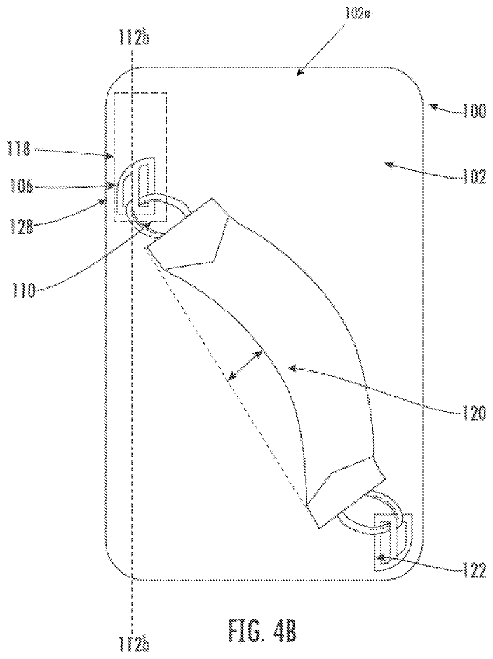

In an embodiment, the attachment assembly 104, comprising the first attachment member 106 and the second attachment member 122, is removably coupled to a housing 102 of the device 100. The housing 102 of the device 100 may have a rear surface 102a. In an embodiment, the first attachment member 106 may be positioned diagonally opposite to the second attachment member 122 along a first axis 112a or 112b of the housing 102 of the device 100. In an embodiment, the first axis may be a diagonal axis 112a of the housing 102 (as exemplarily illustrated in FIG. 1(A)). In an embodiment, the diagonal axis 112a may correspond to an axis that may pass through a first corner 136 and a second corner 138 of the housing 102. In an example implementation, the diagonal axis 112a may be inclined at a predetermined angle, for example, of about 30°, 50°, 60°, etc., with respect to a longitudinal axis 112b (as exemplarily illustrated in FIG. 4(A)). In another embodiment, the first axis may correspond to the longitudinal axis 112b of the housing 102.

In an embodiment, the rear surface 102a of the housing 102 may define a first recess 118 at a first location 114 extending along a first axis 112a or 112b of the housing 102. In an embodiment, the first location 114 refers to an area on the rear surface 102a of the housing 102 such as, a corner location, where the sliding movement of the first attachment member 106 occurs. For example, the first location 114 may be proximal to a first corner 136 of the housing 102. In some examples, the first recess 118 may extend between a first location point 117 and a second location point 119 on the housing 102 along the first axis 112a or 112b. In an example embodiment, the first location point 117 may be proximal to the first corner 136 of the housing 102, and the second location point 119 may correspond to a location along the first axis 112a or 112b of the housing 102. The second location point 119 may be distal from the first corner 136 of the housing 102.

In an example embodiment, the first attachment member 106 is configured to be slidably received within the first recess 118 to allow the sliding movement of the first attachment member 106 between the first location point 117 and the second location point 119 along the first axis 112a or 112b at the first location 114. In an embodiment, the first axis corresponds to the diagonal axis 112a of the housing 102 and the first attachment member 106 may be slid diagonally along the diagonal axis 112a between the first location point 117 and the second location point 119, as exemplarily illustrated and described in the detailed description of FIG. 2(A). Additionally, or alternatively, the rear surface 102a of the housing 102 may define a second recess (not shown) at a second location 126 of the housing 102. In an embodiment, the second location 126 refers to an area on the rear surface 102a of the housing 102 where the second attachment member 122 is placed. In an example embodiment, the second location 126 may be proximal to the second corner 138 of the housing 102. In some examples, the second location 126 may be diagonally opposite to the first location 114.

In an embodiment, the positioning of the first attachment member 106 in the first position 116 at the first location 114 and the second attachment member 122 at the second location 126, places the strap 120 at a diagonal orientation with respect to the rear surface 102a of the housing 102. The diagonal orientation of the strap 120 obtained by coupling the strap 120 to the first attachment member 106 in the first position 116 at the first location 114 and the second attachment member 122 at the second location 126, allows the insertion of the hand 134 through the strap 120 at a predetermined angle which is optimal for ergonomic placement of the device 100 on the hand 134 of the user 130. In an embodiment, the predetermined angle of insertion for the hand operation of the device 100 is in the range of about 20° to about 60°.

In an embodiment, when the first axis corresponds to the diagonal axis 112a of the housing 102 and the first attachment member 106 is in the first position 116, the strap 120 is substantially taut to provide a comfortable fit to the user 130 carrying the device 100 on the hand 134 of the user 130, as exemplarily illustrated in FIGS. 1(A)-1(B). In this embodiment, when the first attachment member 106 is slid from the first position 116 to the second position 128 within the first recess 118 along the first axis corresponding to the diagonal axis 112a, the strap 120 is substantially loose to provide a comfortable fit to the user 130 carrying the device 100 on the forearm 132 of the user 130, as exemplarily illustrated in FIGS. 2(A)-2(B).

In another embodiment, the first axis corresponds to the longitudinal axis 112b of the housing 102 and the first attachment member 106 may be slid between the first location point 117 and the second location point 119 of the first recess 118 at the first location 114 along the longitudinal axis 112b, as exemplarily illustrated and described in the detailed description of FIGS. 4(A)-4(B). To this end, in an embodiment, the first location point 117 may be proximal to the first corner 136 of the housing 102 and the second location point 119 may be distal from the first corner 136 along the longitudinal axis 112b of the housing 102. In an embodiment, when the first axis corresponds to the longitudinal axis 112b of the housing 102 and the first attachment member 106 is in the first position 116 at the first location point 117 of the first recess 118, the strap 120 is substantially taut to provide a comfortable fit to the user 130 carrying the device 100 on the hand 134 of the user 130. In this embodiment, when the first attachment member 106 is in the second position 128 at the second location point 119 of the first recess 118, the strap 120 is substantially loose to provide a comfortable fit to the user 130 carrying the device 100 on the forearm 132 of the user 130.

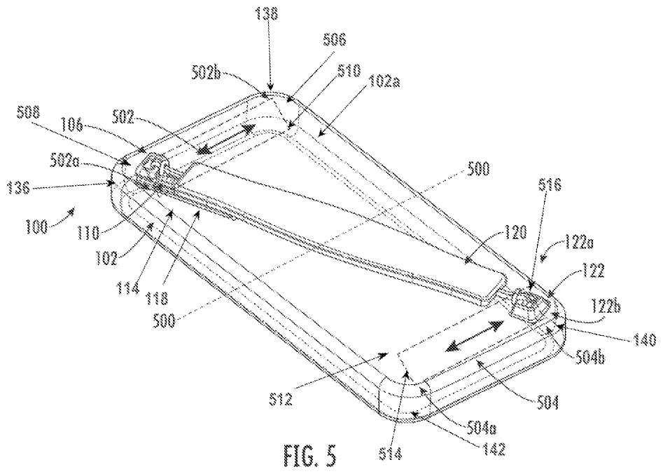

In another embodiment, the scope of the disclosure is not limited to the first axis comprising the diagonal axis 112a or the longitudinal axis 112b but may further comprise a lateral axis 500 of the housing 102, as exemplarily illustrated in FIG. 5. In such an embodiment (not shown), the first attachment member 106 may slide between the first location point 117 and the second location point 119 of the first recess 118 along the lateral axis 500 of the housing 102. In this embodiment, the first location point 117 may be proximal to the first corner 136 of the housing 102 and the second location point 119 may be distal from the first corner 136 along the lateral axis 500 of the housing 102. In an embodiment, when the first axis corresponds to the lateral axis 500 of the housing 102 and the first attachment member 106 is in the first position 116 at the first location point 117 of the first recess 118 along the lateral axis 500, the strap 120 is substantially taut to provide a comfortable fit to the user 130 carrying the device 100 on the hand 134 of the user 130. In this embodiment, when the first attachment member 106 is in the second position 128 at the second location point 119 of the first recess 118 along the lateral axis 500, the strap 120 is substantially loose to provide a comfortable fit to the user 130 carrying the device 100 on the forearm 132 of the user 130.

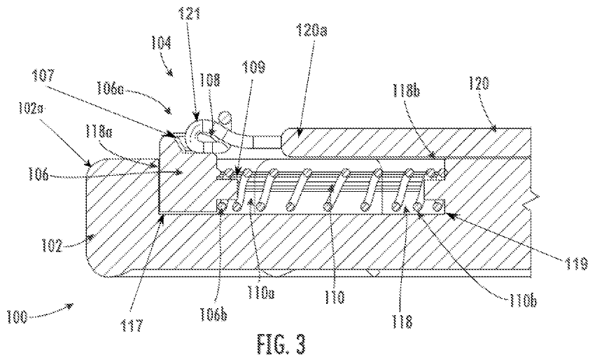

Referring to FIG. 1(A) and FIG. 3, in an embodiment, the first attachment member 106 comprises a first attachment point 108, a first coupling point 109, and a first spring element 110. In an embodiment, the first attachment point 108 is positioned on a top surface 106a of the first attachment member 106 and the first spring element 110 is positioned on a bottom surface 106b of the first attachment member 106, as exemplarily illustrated in FIG. 3. In an embodiment, the first coupling point 109 is positioned on the bottom surface 106b of the first attachment member 106, as exemplarily illustrated in FIG. 3.

In an example embodiment, the first attachment point 108 is configured to be removably coupled to a first end 120a of the strap 120. In an example implementation, the first end 120a of the strap 120 comprises a first loop 121 that is received within a cavity 107 of the first attachment member 106 located at the first attachment point 108, as exemplarily illustrated in FIG. 3. In an embodiment, the first spring element 110 is received within the first recess 118, such that a first end 110a of the first spring element 110 is coupled to the first coupling point 109 of the first attachment member 106 and a second end 110b of the first spring element 110 is coupled to a second end 118b of the first recess 118, as exemplarily illustrated in FIG. 3. In an example embodiment, the second end 118b may be positioned at the second location point 119 of the first recess 118.

In an embodiment, the first spring element 110 may apply biasing force on the first attachment member 106 to cause the first attachment member 106 to be in the first position 116. In an embodiment, the first position 116 corresponds to the first location point 117 of the first recess 118. Accordingly, when no external force is applied on the first attachment member 106, the first attachment member 106 is retained and locked at the first position 116. In an embodiment, the first position 116 refers to a position of the first attachment member 106 on the rear surface 102a of the housing 102 where the first attachment member 106 is locked by the first spring element 110 by exertion of a predetermined amount of force on the first attachment member 106. In an embodiment, as discussed, in response to the first attachment member 106 being in the first position 116, the tension in the strap 120 is configurable to allow insertion of the hand 134 of the user 130 through the strap 120. In an example embodiment, when an external force is applied on the first attachment member 106, the first attachment member 106 may move to the second position 128 corresponding to the second location point 119 of the first recess 118. In the second position 128, the first attachment member 106 may get locked. For example, when the first attachment member 106 is moved to the second position 128, a ramp locking element (not shown) positioned within the first recess 118 slides to lock the first attachment member 106 in the second position 128.

In another embodiment (not shown), a side button is operably connected to a side surface of the first attachment member 106 via a spring element. The side surface of the first attachment member 106 is proximal to the first corner 136 of the housing 102. A first end of the spring element is connected to the side button and a second end of the spring element is connected to the first attachment member 106. The first attachment member 106 is held in the first position 116 by a ramp locking element positioned in contact with the first attachment member 106. The ramp locking element is positioned on another side surface of the first attachment member 106 that is opposite to the side surface of the first attachment member 106 connected to the spring element. When the side button is pressed by the user 130, the ramp locking element is pushed away and the first attachment member 106 is released from the first position 116 to momentarily slide within the first recess 118 to the second position 128. When the user 130 wishes to move the first attachment member 106 to the first position 116, he/she may push the first attachment member 106 within the first recess 118, where the ramp locking element moves back in contact with the first attachment member 106 and locks the first attachment member 106 in the first position 116.

In another embodiment (not shown), the first attachment member 106 is positioned proximal to a first central location (not shown) between the first corner 136 and a third corner 140 of the housing 102 and the second attachment member 122 is positioned proximal to a second central location (not shown) between the second corner 138 and a fourth corner 142 of the housing 102. In an example embodiment, the third corner 140 may correspond to a corner that is opposite to the second corner 138 along the longitudinal axis 112b of the housing 102 and the fourth corner 142 may correspond to a corner that is opposite to the first corner 136 along the longitudinal axis 112b of the housing 102. In this embodiment, the first attachment member 106 is positioned opposite to the second attachment member 122 along the longitudinal axis 112b of the housing 102.

In another embodiment (not shown), the first attachment member 106 is positioned proximal to a third central location (not shown) between the first corner 136 and the fourth corner 142 of the housing 102 and the second attachment member 122 is positioned proximal to a fourth central location (not shown) between the third corner 140 and the second corner 138 of the housing 102. In this embodiment, the first attachment member 106 is positioned opposite to the second attachment member 122 along the lateral axis 500 (exemplarily illustrated in FIG. 5) of the housing 102.

In an embodiment, the second attachment member 122 comprises a second attachment point 124. The second attachment point 124 is positioned on a top surface 122a of the second attachment member 122. The second attachment point 124 is configured to be removably coupled to a second end 120b of the strap 120, as exemplarily illustrated in FIG. 1(A). In an embodiment, a bottom surface 122b of the second attachment member 122 is coupled to the rear surface 102a of the housing 102.

In some examples, the scope of the disclosure is not limited to the first attachment member 106 being slidable along the first axis, for example, the diagonal axis 112a of the housing 102 to configure the tension in the strap 120 based on the sliding movement of the first attachment member 106. In another embodiment (not shown), the second attachment member 122 is also slidable along the first axis, for example, the diagonal axis 112a of the housing 102 to configure the tension in the strap 120 based on the sliding movement of the second attachment member 122, alone or in combination with the sliding movement of the first attachment member 106 along the first axis, for example, the diagonal axis 112a. In this embodiment, the housing 102 further comprises a second recess (not shown) extending along the first axis, for example, the diagonal axis 112a of the housing 102 at the second location 126. The second attachment member 122 is configured to be slidably received within the second recess to be slidable along the first axis, for example, the diagonal axis 112a of the housing 102. In an embodiment, the tension in the strap 120 is further configurable based on the sliding movement of the second attachment member 122. In an example implementation, based on the user's preference, the user 130 may slide the first attachment member 106 or the second attachment member 122, either alone or in combination, to configure the tension in the strap 120.

In some examples, the scope of the disclosure is not limited to the first attachment member 106 and the second attachment member 122 being received in the first recess 118 and the second recess. In an example embodiment, the first attachment member 106 and the second attachment member 122 may be coupled to the housing 102 through an adhesive. In such an embodiment, the housing 102 of the device 100 may not include the first recess 118 and the second recess. Further, in such an embodiment, the first attachment member 106 may include rails on which the first attachment member 106 is slidable. In another such embodiment, the second attachment member 122 may include rails on which the second attachment member 122 is slidable. The adhesive comprises, for example, a glue, an adhesive tape, a thermo-adhesive material, or any other form of adhesive fastener. In an example implementation, an adhesive layer (not shown) is applied to the bottom surface 106b and 122b of each of the first attachment member 106 and the second attachment member 122, respectively. A protective layer (not shown) is removably attached to the adhesive layer to cover the adhesive layer until it is time for application of the adhesive layer to the rear surface 102a of the housing 102. The protective layer is removed to expose the adhesive layer that is used to attach the first attachment member 106 to the rear surface 102a of the housing 102 at the first location 114. Similarly, the second attachment member 122 may be attached to the rear surface 102a of the housing 102 at the second location 126 using the adhesive.

In another embodiment, the first attachment member 106 and the second attachment member 122 are embedded into the rear surface (not shown) of the device 100 at the first location 114 and the second location 126, respectively. For example, the first recess 118 is engraved in the rear surface of the device 100 at the first location 114 to slidably receive the first attachment member 106. Further, in this example, the second attachment member 122 is embedded into the rear surface of the device 100 at the second location 126.

As discussed in FIG. 1(A), the first attachment member 106 and the second attachment member 122 are configured to be coupled to the strap 120. In an embodiment, dimensions and/or a material of the strap 120 are predetermined to comfortably secure the device 100 on the forearm 132 or the hand 134 of the user 130, with desirable ergonomic effects. Few examples of desirable ergonomic effects include a comfortable grip of the device 100, minimal or negligible wrist or forearm deviation to comfortably access the device 100, better stability, reduced efforts required for multi-tasking, etc. In an example implementation, the material of the strap 120 comprises any material with substantial elasticity to allow configuration of the tension in the strap 120. For example, the material is made of elastic, microfiber, natural rubber, synthetic rubber, nitrile rubber, silicone rubber, urethane rubbers, chloroprene rubber, etc. In an example implementation, the elasticity of the strap 120 is in the range of about 0.4 gigapascal to about 1 gigapascal to achieve the desired ergonomic effects for the hand operation or the forearm operation of the device 100. In an example implementation, for a device 100 with dimensions of 4 inches by 6 inches, length of the strap 120 is in the range of about 3 inches to about 5 inches, width of the strap 120 is in the range of about 0.5 inch to about 2 inches, and thickness of the strap 120 is in the range of about 0.1 inch to about 0.5 inch. In some example implementations, the scope of the disclosure is not limited to dimensions of the strap 120 as described above and may vary depending on dimensions of the device 100 and/or the housing 102 on which the attachment assembly 104 is to be removably coupled.

The tension in the strap 120 is configurable based on the sliding movement of the first attachment member 106. For example, when the first attachment member 106 is in the first position 116, the tension in the strap 120 is configurable to allow insertion of the hand 134 of the user 130 through the strap 120, as exemplarily illustrated and described in detailed description of FIGS. 1(A) and 1(B). In another example, when the first attachment member 106 is slid to the second position 128, the tension in the strap 120 is configurable to allow insertion of the forearm 132 of the user 130 through the strap 120, as exemplarily illustrated and described in detailed description of FIGS. 2(A) and 2(B).

FIG. 1(B) exemplarily illustrates a front perspective view of the device 100 ergonomically positioned on the hand 134 of the user 130 with the use of the attachment assembly 104, according to one or more embodiments described herein. In an example implementation, the user 130 inserts his/her hand 134 through the strap 120 when the first attachment member 106 is locked at the first position 116. In an embodiment, the first position 116 is predetermined to ensure that the device 100 is ergonomically secured to the hand 134 of the user 130 in a tight-fit manner. With the use of the attachment assembly 104 as disclosed herein, the device 100 is not positioned substantially perpendicular to the hand 134 of the user 130, thereby allowing the user 130 to single-handedly manipulate the device 100 with ease.

FIGS. 2(A)-2(B) exemplarily illustrate perspective views of the device 100 comprising the attachment assembly 104 to secure the device 100 to the forearm 132 of the user 130, according to one or more embodiments described herein. As exemplarily illustrated in FIG. 2(A), the first attachment member 106 is at the second position 128. In an embodiment, the first attachment member 106 is slid along the first axis, for example, the diagonal axis 112a of the housing 102 of the device 100, from the first position 116 to the second position 128. In an embodiment, the first attachment member 106 is locked at the second position 128 to ensure that the first attachment member 106 is not displaced when the device 100 is secured to the forearm 132 of the user 130.

In response to the first attachment member 106 being in the second position 128, the tension in the strap 120 is configurable to allow insertion of the forearm 132 of the user 130 through the strap 120. In an embodiment, the diagonal orientation of the strap 120, obtained by coupling the strap 120 to the first attachment member 106 in the first position 116 at the first location 114 and the second attachment member 122 at the second location 126, allows the insertion of the forearm 132 through the strap 120 at a predetermined angle. In an embodiment, the predetermined angle of insertion for the forearm operation of the device 100 is in the range of about 30° to about 60°, which is optimal for ergonomically securing the device 100 to the forearm 132 of the user 130.

In an embodiment, the scope of the disclosure is not limited to the first attachment member 106 being slidable along the first axis, for example, the diagonal axis 112a of the housing 102 to configure the tension in the strap 120 based on the sliding movement of the first attachment member 106. In another embodiment (not shown), the second attachment member 122 is also slidable along the first axis, for example, the diagonal axis 112a of the housing 102. When the user 130 further needs to expand a loop formed by the sliding movement of the first attachment member 106 for the forearm operation of the device 100, the user 130 may slide the second attachment member 122 within the second recess (not shown) along the first axis, for example, the diagonal axis 112a of the housing 102.

FIG. 3 illustrates a left side sectional view of a portion of the device 100 comprising the first attachment member 106 coupled to the strap 120, according to one or more embodiments described herein. As exemplarily illustrated in FIG. 3, the first end 120a of the strap 120 is removably coupled to the first attachment member 106 at the first attachment point 108. The first coupling point 109 of the first attachment member 106 is operably coupled to the first end 110a of the first spring element 110. When the first spring element 110 applies biasing force on the first attachment member 106 to cause the first attachment member 106 to be in the first position 116, the first attachment member 106 is in contact with a first end 118a of the first recess 118 at the first location point 117. The second end 118b of the first recess 118 is coupled to a second end 110b of the first spring element 110 at the second location point 119.

When the first attachment member 106 is in the first position 116, the tension in the strap 120 is configured to allow insertion of the hand 134 of the user 130 through the strap 120. For the forearm operation of the device 100, the first attachment member 106 may be slid within the first recess 118 to the second position 128 by application of an external force on the first attachment member 106, as described in the detailed description of FIG. 1(B).

FIGS. 4(A)-4(B) exemplarily illustrate rear views of the device 100 depicting configurations of the attachment assembly 104, according to one or more embodiments described herein. As exemplarily illustrated in FIGS. 4(A)-4(B), the attachment assembly 104 comprises the first attachment member 106 slidable along the first axis, for example, a longitudinal axis 112b of the housing 102 of the device 100.

FIG. 4(A) exemplarily illustrates a rear view of the device 100 comprising the first attachment member 106 in the first position 116 at the first location 114 on the rear surface 102a of the housing 102, according to one or more embodiments described herein. In an embodiment, the rear surface 102a of the housing 102 may define the first recess 118 at the first location 114 extending along the first axis corresponding to the longitudinal axis 112b of the housing 102. The first recess 118 may extend between the first location point 117 and the second location point 119 on the housing 102 along the longitudinal axis 112b. In an example embodiment, the first location point 117 may be proximal to the first corner 136 of the housing 102, and the second location point 119 may correspond to a location distal from the first corner 136 along the longitudinal axis 112b.

In an embodiment, the first attachment member 106 is positioned diagonally opposite to the second attachment member 122 along the diagonal axis 112a that passes through the first corner 136 and the second corner 138 of the housing 102. In response to the first attachment member 106 being in the first position 116, the tension in the strap 120 is configurable to allow insertion of the hand 134 of the user 130 through the strap 120. In an embodiment, the first attachment member 106 is locked in the first position 116 to avoid displacement of the first attachment member 106 along the longitudinal axis 112b during hand operation of the device 100, as described in the detailed description of FIGS. 1(A)-1(B).

FIG. 4(B) exemplarily illustrates another rear view of the device 100 comprising the first attachment member 106 in the second position 128 at the first location 114 on the rear surface 102a of the housing 102, according to one or more embodiments described herein. In this embodiment, the first attachment member 106 is slidably received within the first recess 118 to be slidable along the longitudinal axis 112b. The first attachment member 106 slides along the longitudinal axis 112b between the first location point 117 and the second location point 119 of the first recess 118, to be placed in the second position 128. In response to the first attachment member 106 being in the second position 128, the tension in the strap 120 is configurable to allow insertion of the forearm 132 of the user 130 through the strap 120. In an embodiment, the first attachment member 106 is locked in the second position 128 to avoid displacement of the first attachment member 106 along the longitudinal axis 112b during the forearm operation of the device 100, as described in the detailed description of FIGS. 2(A)-2(B).

FIG. 5 exemplarily illustrates another rear view of the device 100 depicting another configuration of the attachment assembly 104, according to one or more embodiments described herein. In an embodiment, the first attachment member 106 and the second attachment member 122 of the attachment assembly 104 are slidable on the rear surface 102a of the housing 102 along a second axis of the housing 102 of the device 100. In an embodiment, the second axis corresponds to a lateral axis 500 of the housing 102.

In an embodiment, as discussed, the rear surface 102a of the housing 102 defines the first recess 118 at the first location 114 extending along the first axis corresponding to the diagonal axis 112a of the housing 102. In an example implementation, the diagonal axis 112a passes through the first corner 136 and the second corner 138 of the housing 102. In an example embodiment, the first attachment member 106 is configured to be slidably received within the first recess 118 to allow the sliding movement of the first attachment member 106 between the first location point 117 and the second location point 119 along the diagonal axis 112a at the first location 114, as described in the detailed description of FIGS. 1(A)-1(B) and 2(A)-2(B). In an embodiment, the second attachment member 122 is positioned diagonally opposite to the first attachment member 106 along the first axis corresponding to the diagonal axis 112a. In an embodiment, in response to the first attachment member 106 being in the first position 116, the tension in the strap 120 is configurable to allow insertion of the hand 134 of the user 130 through the strap 120. In an embodiment, in response to the first attachment member 106 being in the second position 128, the tension in the strap 120 is configurable to allow insertion of the forearm 132 of the user 130 through the strap 120.

In an embodiment, the rear surface 102a of the housing 102 defines a first lateral recess 502 at a first lateral location 506 extending along the second axis corresponding to the lateral axis 500 of the housing 102. In an embodiment, the first lateral location 506 refers to an area on the rear surface 102a of the housing 102 such as, a top surface location, where the lateral sliding movement of the first attachment member 106 occurs. For example, the first lateral location 506 may be defined as an area between the first corner 136 and the third corner 140 of the housing 102. In some examples, the first lateral recess 502 may extend between a first lateral location point 508 and a second lateral location point 510 on the housing 102 along the lateral axis 500. In an example embodiment, the first lateral location point 508 may be proximal to the first corner 136 of the housing 102 and the second lateral location point 510 may be proximal to the third corner 140 of the housing 102. In an example embodiment, the first attachment member 106 is configured to be slidably received within the first lateral recess 502 to allow the lateral sliding movement of the first attachment member 106 between the first lateral location point 508 and the second lateral location point 510 along the lateral axis 500 at the first lateral location 506.

In an embodiment, the rear surface 102a of the housing 102 defines a second lateral recess 504 at a second lateral location 512 extending along the second axis corresponding to the lateral axis 500 of the housing 102. In an embodiment, the second lateral location 512 refers to an area on the rear surface 102a of the housing 102 such as, a bottom surface location, where the lateral sliding movement of the second attachment member 122 occurs. For example, the second lateral location 512 may be defined as an area between the fourth corner 142 and the second corner 138 of the housing 102. In some examples, the second lateral recess 504 may extend between a third lateral location point 514 and a fourth lateral location point 516 on the housing 102 along the lateral axis 500. In an example embodiment, the third lateral location point 514 may be proximal to the fourth corner 142 of the housing 102 and the fourth lateral location point 516 may be proximal to the second corner 138 of the housing 102. In an example embodiment, the second attachment member 122 is configured to be slidably received within the second lateral recess 504 to allow the lateral sliding movement of the second attachment member 122 between the third lateral location point 514 and the fourth lateral location point 516 along the lateral axis 500 at the second lateral location 512.

In an embodiment, the first attachment member 106 and the second attachment member 122 are slidable along the second axis corresponding to the lateral axis 500 of the housing 102 in opposing directions to change an orientation of the strap 120. In an example implementation, the orientation of the strap 120 may be changed when the first attachment member 106 and the second attachment member 122 may be slid in opposing directions along the second axis corresponding to the lateral axis 500 based on preference of a right-handed user 130 or a left-handed user 130. For example, if the user 130 is right-handed, the first attachment member 106 is positioned at the first lateral location point 508 of the first lateral recess 502 and the second attachment member 122 is positioned at the fourth lateral location point 516 of the second lateral recess 504, as exemplarily illustrated in FIG. 5. If the user 130 is left-handed, the first attachment member 106 is slid to the second lateral location point 510 of the first lateral recess 502 and the second attachment member 122 is slid to the third lateral location point 514 of the second lateral recess 504, in opposing directions (not shown).

In an embodiment, the first attachment member 106 is slidable along the first axis corresponding to the diagonal axis 112a, in combination with the lateral sliding movement of the first attachment member 106 and the second attachment member 122 along the second axis corresponding to the lateral axis 500 of the housing 102 in opposing directions to change the orientation of the strap 120. In this example, the first attachment member 106 is slidable along the diagonal axis 112a to configure the tension in the strap 120 to allow insertion of the hand 134 or the forearm 132 of the user 130, as exemplarily illustrated and described in the detailed description of FIGS. 1(A), 1(B), 2(A), and 2(B). Further in this example, when the user 130 is right-handed, the first attachment member 106 and the second attachment member 122 are slid along the lateral axis 500 in opposing directions to position the first attachment member 106 at the first lateral location point 508 of the first lateral recess 502 and to position the second attachment member 122 at the fourth lateral location point 516 of the second lateral recess 504, as exemplarily illustrated in FIG. 5.

In another embodiment, the first attachment member 106 and the second attachment member 122 are slidable along the second axis corresponding to the lateral axis 500 of the housing 102 in the same direction to change the angle of insertion of the user's hand 134 or forearm 132 through the strap 120. In an example implementation, the angle of insertion may be changed by sliding the first attachment member 106 by a first distance and the second attachment member 122 by a second distance in the same direction along the lateral axis 500. For example, when the first attachment member 106 is positioned at a first central location point (not shown) of the first lateral recess 502, the angle of insertion of the strap 120 with respect to the longitudinal axis 112b may be changed by sliding the first attachment member 106 by the first distance, for example, 4 mm towards the first corner 136 along the lateral axis 500. Further, the second attachment member 122 positioned at a second central location point (not shown) of the second lateral recess 504, may be slid by the second distance, for example, 1 mm towards the fourth corner 142 along the lateral axis 500.

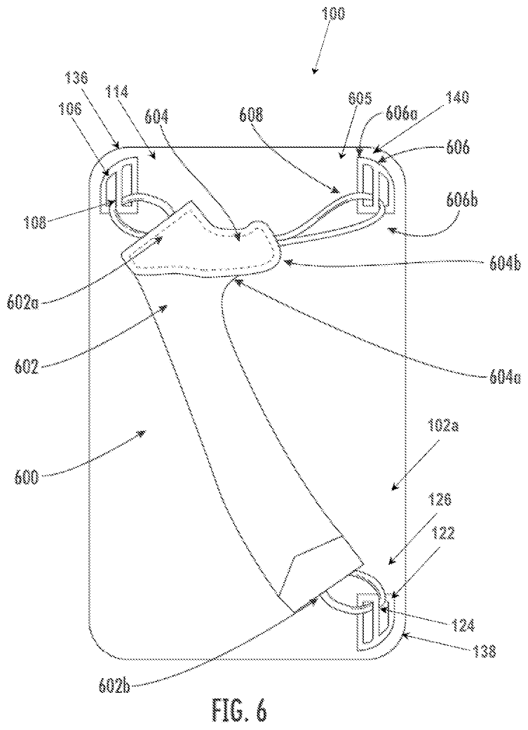

FIG. 6 exemplarily illustrates another rear view of the device 100 depicting another attachment assembly 104, according to one or more embodiments described herein. In an embodiment, the scope of the disclosure is not limited to the attachment assembly 104 comprising the first attachment member 106 and the second attachment member 122 as explained in the detailed description of FIGS. 1(A)-5. In another embodiment, the attachment assembly 104 further comprises a third attachment member 606. In an example embodiment, the attachment assembly 104 comprises the first attachment member 106 at the first location 114, the second attachment member 122 at the second location 126, and the third attachment member 606 at a third location 605 of the housing 102 of the device 100, as exemplarily illustrated in FIG. 6.

In an embodiment, the first attachment member 106 is positioned at the first location 114 and the second attachment member 122 is positioned at the second location 126, as described in the detailed description of FIGS. 1(A)-1(B). For example, the first attachment member 106 is positioned proximal to the first corner 136 of the housing 102 and the second attachment member 122 is positioned proximal to the second corner 138 of the housing 102.

In an embodiment, the third location 605 refers to an area on the rear surface 102a of the housing 102 such as, a corner location, where the third attachment member 606 is positioned. In an example embodiment, the third location 605 is proximal to the third corner 140 of the housing 102. In an embodiment, the third attachment member 606 comprises a third attachment point 608 on a top surface 606a of the third attachment member 606. A bottom surface 606b of the third attachment member 606 is coupled to the rear surface 102a of the housing 102 at the third location 605.

The first attachment member 106, the second attachment member 122, and the third attachment member 606 are configured to be coupled to an adjoined strap assembly 600, as exemplarily illustrated in FIG. 6. The adjoined strap assembly 600 comprises a main strap member 602 and an adjoining strap member 604. In an embodiment, the main strap member 602 is made of a material with high elasticity to configure the main strap member 602 with low tension. In an embodiment, the adjoining strap member 604 is made of a material with substantially low elasticity to configure the adjoining strap member 604 with high tension.

In an example implementation, a first end 602a of the main strap member 602 is coupled to the first attachment member 106 at the first attachment point 108, a second end 602b of the main strap member 602 is coupled to the second attachment member 122 at the second attachment point 124, and a distal end 604b of the adjoining strap member 604 is detachably coupled to the third attachment member 606 at the third attachment point 608. The adjoining strap member 604 is joined with the main strap member 602 at an adjoining end 604a of the adjoining strap member 604.

In an embodiment, the distal end 604b of the adjoining strap member 604 is coupled to the third attachment member 606 to allow insertion of the hand 134 of the user 130 through the adjoined strap assembly 600. In an embodiment, the third location 605 is predetermined to ensure that the device 100 is ergonomically held in the hand 134 of the user 130 in a tight-fit manner when the distal end 604b of the adjoining strap member 604 is coupled to the third attachment member 606.

In another embodiment, the adjoining strap member 604 is detachable from the third attachment member 606 at the distal end 604b to allow insertion of the forearm 132 of the user 130 through the adjoined strap assembly 600. In this embodiment, the adjoined strap assembly 600 comprises the main strap member 602 coupled to the first attachment member 106 at the first end 602a of the main strap member 602 and the second attachment member 122 at the second end 602b of the main strap member 602. The detachment of the adjoining strap member 604 from the third attachment member 606 at the distal end 604b renders the adjoined strap assembly 600 substantially loose to provide a comfortable fit to the user 130 carrying the device 100 on the forearm 132 of the user 130. In an embodiment, the adjoining strap member 604 is removed from the adjoined strap assembly 600 by disconnecting the adjoining end 604a of the adjoining strap member 604 from the main strap member 602. In another embodiment, the distal end 604b of the adjoining strap member 604 is removed from the third attachment member 606 and the adjoining strap member 604 remains connected to the main strap member 602 at the adjoining end 604a, to facilitate quick switching to the forearm operation from the hand operation of the device 100.

In an embodiment, the positioning of the first attachment member 106 at the first location 114, the second attachment member 122 at the second location 126, and the third attachment member 606 at the third location 605 allows the insertion of the hand 134 through the adjoined strap assembly 600 at a predetermined angle which is optimal for ergonomic placement of the device 100 on the hand 134 of the user 130. In an embodiment, the predetermined angle of insertion for the hand operation of the device 100 is in the range of about 30° to about 60°. In another embodiment, the positioning of the first attachment member 106 at the first location 114 and the second attachment member 122 at the second location 126 allows the insertion of the forearm 132 through the adjoined strap assembly 600 at a predetermined angle which is optimal for ergonomic placement of the device 100 on the forearm 132 of the user 130. In an embodiment, the predetermined angle of insertion for the forearm operation of the device 100 is in the range of about 30° to about 60°. In an embodiment, an angle of insertion of the hand 134 of the user 130 is different from an angle of insertion of the forearm 132 of the user 130 through the adjoined strap assembly 600.

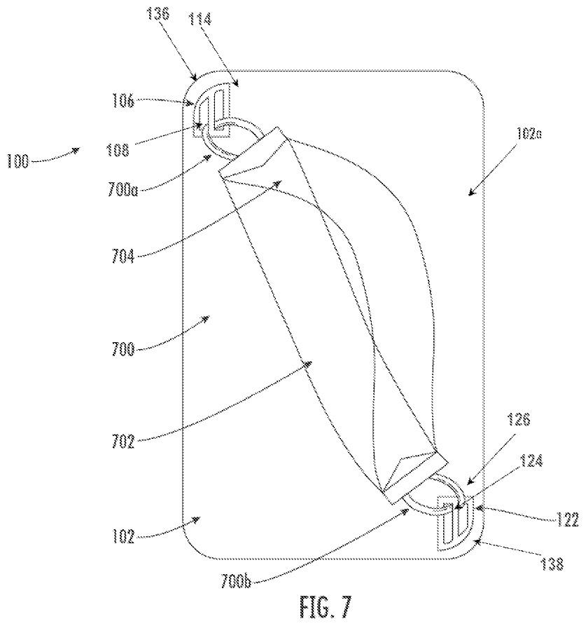

FIG. 7 exemplarily illustrates another rear view of the device 100 depicting yet another attachment assembly 104, according to one or more embodiments described herein. The attachment assembly 104 comprises the first attachment member 106 and the second attachment member 122 configured to be coupled to a looped strap assembly 700, as exemplarily illustrated in FIG. 7. In an embodiment, the first attachment member 106 is positioned at the first location 114 and the second attachment member 122 is positioned at the second location 126, as described in the detailed description of FIGS. 1(A)-1(B). For example, the first attachment member 106 is positioned proximal to the first corner 136 of the housing 102 and the second attachment member 122 is positioned proximal to the second corner 138 of the housing 102.

The looped strap assembly 700 comprises a first strap member 702 and a second strap member 704. A first end 700a of the looped strap assembly 700 is coupled to the first attachment member 106 at the first attachment point 108 and a second end 700b of the looped strap assembly 700 is coupled to the second attachment member 122 at the second attachment point 124.

In an embodiment, the first strap member 702 allows insertion of the hand 134 of the user 130. In an embodiment, the first strap member 702 is made of a material with substantially low elasticity to configure the first strap member 702 with substantially low tension. Consequently, a first loop formed by the first strap member 702 is substantially tight to allow the insertion of the hand 134 through the first strap member 702 at a predetermined angle which is optimal for ergonomic placement of the device 100 on the hand 134 of the user 130.

In an embodiment, the second strap member 704 allows insertion of the forearm 132 of the user 130. In an embodiment, the second strap member 704 is made of a material with substantially high elasticity to configure the second strap member 704 with substantially high tension, thereby avoiding lose hanging of the second strap member 704 that may interfere with efficient use of the device 100. For example, a taut second strap member 704 allows the user 130 to routinely and time-efficiently switch between the first strap member 702 and the second strap member 704 to switch between the hand operation and the forearm operation of the device 100. When the user 130 wants to place the device 100 on the forearm 132, the user 130 may remove the hand 134 from the first strap member 702 and quickly insert the forearm 132 through the second strap member 704. A second loop formed by the second strap member 704 is substantially loose to allow the insertion of the forearm 132 through the second strap member 704 at a predetermined angle which is optimal for ergonomic placement of the device 100 on the forearm 132 of the user 130.

In another embodiment (not shown), the attachment assembly 104 further comprises a third attachment member (not shown) and a fourth attachment member (not shown) diagonally opposite to each other. In an example implement, the third attachment member is positioned at a third location proximal to the third corner 140 of the housing 102 and the fourth attachment member is positioned proximal to the fourth corner 142 of the housing 102. Consequently, the housing 102 of the device 100 comprises an attachment member at all four corners of the housing 102. In this embodiment, the first end 700a and the second end 700b of the looped strap assembly 700 are divided into two sections. For example, a first section of the first end 700a proximal to the first attachment member 106 is coupled to the first attachment member 106 and a second section of the second end 700b proximal to the second attachment member 122 is coupled to the second attachment member 122 to form the second strap member 704 with substantially high elasticity to allow insertion of the forearm 132 through the second strap member 704. Further, a second section of the first end 700a proximal to the third attachment member is coupled to the third attachment member and a first section of the second end 700b proximal to the fourth attachment member is coupled to the fourth attachment member to form the first strap member 702 with substantially low elasticity to allow insertion of the hand 134 through the first strap member 702. Hence, when the user 130 wants to place the device 100 on the forearm 132, the user 130 may remove the hand 134 from the first strap member 702 and quickly insert the forearm 132 through the second strap member 704.

In the specification and figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing detailed description has set forth various embodiments of the devices and/or processes via the use of schematics, exemplary, and examples. Insofar as such schematics and examples contain one or more functions and/or operations, each function and/or operation within such schematics or examples can be implemented, individually and/or collectively, by a wide range of hardware thereof.

The various embodiments described above can be combined with one another to provide further embodiments. For example, two or more of example embodiments described above may be combined to, for example, efficiently and quickly switch between hand operation and forearm operation of the device with desired ergonomic effects. These and other changes may be made to the present apparatuses in light of the above detailed description. Accordingly, the disclosure is not limited by the disclosure, but instead its scope is to be determined by the following claims.

1. An attachment assembly for a device, the attachment assembly comprising:
a first attachment member slidable along a first axis of the device at a first location; and
a second attachment member at a second location,
wherein the first attachment member and the second attachment member are configured to be coupled to a strap, and wherein a tension in the strap is configurable based on a sliding movement of the first attachment member.

2. The attachment assembly of claim 1, wherein the first axis comprises one of a longitudinal axis or a diagonal axis of the device.

3. The attachment assembly of claim 1, wherein the second attachment member is slidable along the first axis of the device, and wherein the tension in the strap is further configurable based on a sliding movement of the second attachment member.

4. The attachment assembly of claim 1, wherein in response to the first attachment member being in a first position, the tension in the strap is configurable to allow insertion of a hand of a user through the strap.

5. The attachment assembly of claim 1, wherein, in response to the first attachment member being in a second position, the tension in the strap is configurable to allow insertion of a forearm of a user through the strap.

6. The attachment assembly of claim 1, wherein the first attachment member and the second attachment member are slidable along a second axis of the device in opposing directions to change an orientation of the strap.

7. The attachment assembly of claim 6, wherein the second axis comprises a lateral axis of the device.

8. A device comprising:
a housing comprising:
a first attachment member slidable along a first axis of the housing at a first location; and
a second attachment member positioned at a second location,
wherein the first attachment member and the second attachment member are configured to be coupled to a strap, and wherein a tension in the strap is configurable based on a sliding movement of the first attachment member.

9. The device of claim 8, wherein the first axis comprises one of a longitudinal axis or a diagonal axis of the housing.

10. The device of claim 8, wherein the second attachment member is slidable along the first axis of the housing, and wherein the tension in the strap is further configurable based on a sliding movement of the second attachment member.

11. The device of claim 8, wherein in response to the first attachment member being in a first position, the tension in the strap is configurable to allow insertion of a hand of a user through the strap.

12. The device of claim 8, wherein in response to the first attachment member being in a second position, the tension in the strap is configurable to allow insertion of a forearm of a user through the strap.

13. The device of claim 8, wherein the first attachment member and the second attachment member are slidable along a second axis of the housing in opposing directions to change an orientation of the strap.

14. The device of claim 13, wherein the second axis comprises a lateral axis of the housing.

15. A device comprising:
a housing comprising:
a first recess extending along a first axis of the housing at a first location;
a first attachment member configured to be slidably received within the first recess, wherein the first attachment member is slidable along the first axis of the housing; and
a second attachment member at a second location,
wherein the first attachment member and the second attachment member are configured to be coupled to a strap, and wherein a tension in the strap is configurable based on a sliding movement of the first attachment member.

16. The device of claim 15, further comprising:
a second recess extending along the first axis of the housing,
wherein the second attachment member is configured to be slidably received within the second recess to be slidable along the first axis of the housing, and wherein the tension in the strap is further configurable based on a sliding movement of the second attachment member.

17. The device of claim 15, wherein in response to the first attachment member being in a first position, the tension in the strap is configurable to allow insertion of a hand of a user through the strap.

18. The device of claim 15, wherein in response to the first attachment member being in a second position, the tension in the strap is configurable to allow insertion of a forearm of a user through the strap.

19. The device of claim 15, wherein the first attachment member and the second attachment member are slidable along a second axis of the housing in opposing directions to change an orientation of the strap.

20. The device of claim 19, wherein the second axis comprises a lateral axis of the housing.
